(19) United States
(12) Patent Application Publication
(10) Pub. No.: US 2005/0274129 A1
(43) Pub. Date: Dec. 15, 2005

(54) Cryogenic adsorption pump for the collection of airborne gases, particles, organic molecules and micro-organisms

(76) Inventors: Vitaly J. Vodyanoy, Auburn, AL (US); Tatiana I. Samoylova, Auburn, AL (US); Timothy E. Moore, Jacksonville, AL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/149,767

(22) Filed: Jun. 10, 2005

Related U.S. Application Data
(60) Provisional application No. 60/579,118, filed on Jun. 12, 2004.

(51) Int. Cl. B01D 8/00; F25J 1/00

(52) U.S. Cl. 62/55.5; 62/606

(57) ABSTRACT

A cryogenic adsorption pump, system and method including adsorbent material contained in a first container, wherein the first container is cooled inside of a second container. The second container is filled with a cryogenic liquid to effectuate the cooling of the first container, creating a vacuum in the first container. A valve of the first container is opened, thereby allowing the vacuum to collect an air sample many times the volume of the first container, and allowing the adsorbent material to collect and contain airborne particles. The collected air and particles are retrieved and tested by heating the first container or allowing the first container to reach room temperature, and opening the first valve.

### CROSS REFERENCE TO RELATED APPLICATIONS

This application claims priority under 35 U.S.C. §119(e) of the co-pending U.S. Provisional Patent Application, Ser. No. 60/579,118, filed Jun. 12, 2004, and entitled “CRYOGENIC ADSORPTION PUMP FOR THE COLLECTION OF AIRBORNE GASES, PARTICLES, ORGANIC MOLECULES AND MICRO-ORGANISMS”. The Provisional Patent Application, Ser. No. 60/579,118, filed Jun. 12, 2004, and entitled “CRYOGENIC ADSORPTION PUMP FOR THE COLLECTION OF AIRBORNE GASES, PARTICLES, ORGANIC MOLECULES AND MICRO-ORGANISMS” is also hereby incorporated by reference.

### FIELD OF THE INVENTION

The invention relates to the field of adsorption devices. More particularly, the invention relates to the field of cryogenic adsorption pumps.

### BACKGROUND OF THE INVENTION

When buildings, rooms or containers are contaminated, a sample collection or evaluation of conditions may be required when it is too dangerous to enter and/or no electric power is available to use conventional collection devices. An apparatus, system or method is needed that is capable of collecting airborne particles or volatile compounds. The apparatus, system and method is needed to be simple, for a rapid and efficient collection of airborne samples without the need of an operator or power during the actual collection activity.

FIG. 1 illustrates a graphical representation of a prior art adsorption device 10. This adsorption device 10 includes adsorbent material 20, such as activated charcoal, enclosed in the adsorption device 10. The adsorption device 10 includes a valve 30 and a collection hose 40, such that when the valve 30 is opened, an air sample is collected through the collection hose 40 into the adsorption device 10. Any airborne gases, particles, organic molecules or micro-organisms found in the air sample are adsorbed by the adsorption material 20 in the adsorption device 10. This adsorption device 10 is limited in that it requires external vacuum pumps in order to remove the air sample from the adsorption device 10 for testing or further storage at a later date. Furthermore, this adsorption device 10 is limited in capacity, as no vacuum is utilized to collect the air sample.

### SUMMARY OF THE INVENTION

A cryogenic adsorption pump, system and method including adsorbent material contained in a first container, wherein the first container is cooled inside of a second container. The second container is filled with a cryogenic liquid to effectuate the cooling of the first container, creating a vacuum in the first container. A valve of the first container is opened, thereby allowing the vacuum to collect an air sample many times the volume of the first container, and allowing the adsorbent material to collect and contain airborne particles. The collected air and particles are retrieved and tested by heating the first container or allowing the first container to reach room temperature, and opening the first valve.

A cryogenic adsorption pump for collecting an air sample comprising a first container having a first valve, wherein an adsorbent material is configured inside of the first container and a second container configured to house the first container, the second container further configured to cryogenically cool the first container, wherein when the first valve is closed and the first container is cooled, a vacuum is produced in the first container such that when the first valve is opened, the air sample is collected.

The first container stops collecting the air sample when the first container is full or when the valve is closed, wherein when the first container is full, closing the valve prevents the air sample from being released.

A heating element is configured to heat the first container, wherein the heating of the first container and opening the valve causes the air sample to be expelled from the first container. The second container cools the first container with a cryogenic liquid, and is preferably a dewer vessel.

A cryogenic adsorption system for collecting and analyzing an air sample comprising an adsorption pump configured to collect the air sample, the adsorption pump including a first container having a first valve, wherein an adsorbent material is configured inside of the first container and a second container configured to house the first container, the second container further configured to cryogenically cool the first container, wherein when the first valve is closed and the first container is cooled, a vacuum is produced in the first container such that when the first valve is opened, the air sample is colleted. The cryogenic adsorption system further comprising a heating element configured to heat the first container, wherein heating the first container and opening the valve causes the air sample to be expelled from the first container, a sampling hose coupled to the first container and configured to collect the air sample, and a collection device configured to receive the air sample by coupling the sampling hose to the collection device when the heating element is expelling the air sample.

The cryogenic adsorption system, wherein the first container stops collecting the air sample when the first container is full or when the valve is closed, further wherein when the first container is full, closing the valve prevents the air sample from being released. The cryogenic adsorption system further wherein the second container cools the first container with a cryogenic liquid, the second container is preferably a dewer vessel, the collection device is a large capacity storage device or a sampling system.

A method of collecting an air sample comprising configuring an adsorption material in a first container, cooling the first container with a cryogenic liquid, wherein the cryogenic liquid and the first container are configured in a second container, further wherein the cooling step causes a vacuum to form in the first container, opening a valve of the first container such that the vacuum collects an air sample, and closing the valve, thus containing the air sample in the first container.

The method of collecting an air sample further comprising heating the first container such that the air sample is expelled from the first container, wherein the first container stops collecting the air sample when the first container is full or when the valve is closed, further wherein when the first container is full, closing the valve prevents the air sample from being released, and wherein the second container is preferably a dewer vessel further comprising a sampling hose coupled to the first container and configured to collect the air sample.

### BRIEF DESCRIPTION OF THE DRAWINGS

FIG. 1 illustrates a graphical representation of an adsorption device of the prior art.

FIG. 2 illustrates a graphical representation of a cryogenic adsorption pump in accordance with the present invention.

FIG. 3 illustrates a block diagram of a cryogenic adsorption system in accordance with the present invention.

FIG. 4 illustrates a flow chart of a method in accordance of the present invention.

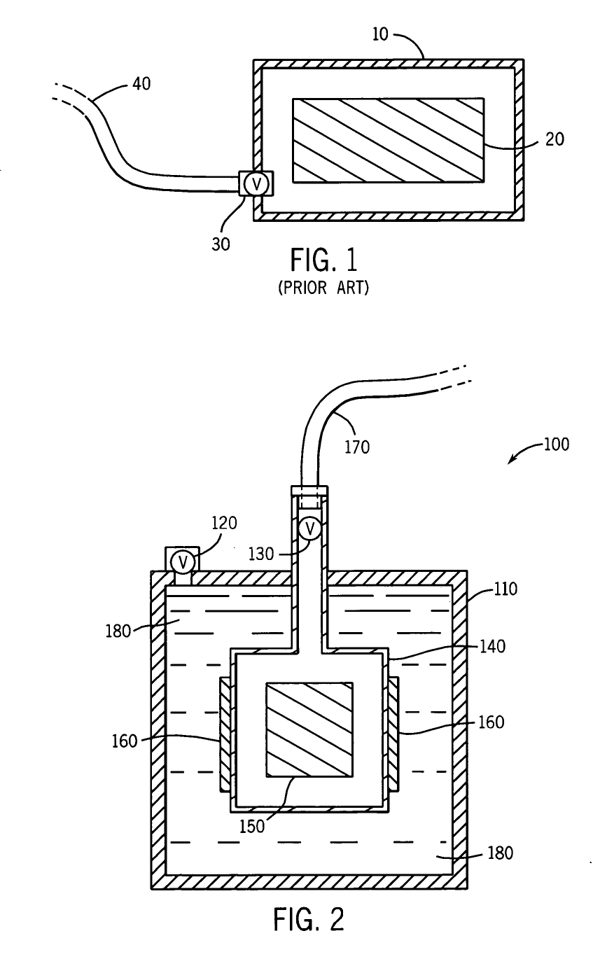

### DETAILED DESCRIPTION OF THE INVENTION

An adsorption apparatus for collecting and containing hazardous airborne particles and volatiles (e.g. spores, vapors, TICs/TIMs and CWM) from a building, room or a container is herein disclosed and described. The adsorption apparatus functions by using high capacity pre-cooled adsorbent media and does not require external energy to operate during the collection modality. Preferably, the apparatus includes a cryogenic pump and an embedded heater. The apparatus is charged by liquid nitrogen, or some other cryogenic liquid, and is preferably configured to contain the sample for up to 8 hours. The apparatus is configured to collect the sample through a small opening in a building, room, or container by either direct placement of the apparatus or remotely via a sampling hose.

Collection occurs when the collection valve of the apparatus is opened. The apparatus then collects air from the target area under high vacuum. Collection continues until the valve is closed or the apparatus is full. The particles are adsorbed by a high-capacity adsorbent matrix contained in the device. The apparatus can collect samples from several ports and from different rooms and/or structures. The apparatus may be emptied by heating the adsorbent media with an embedded heater or by simply allowing the adsorbent material to reach room temperature. The apparatus may be emptied into a larger storage container or directly into a sampling and/or identification system, such as, but not limited to, a system Mass Spectrometer. Preferably, the apparatus may be re-used an unlimited number of times.

FIG. 2 illustrates a graphical representation of a cryogenic adsorption pump 100. In this cryogenic adsorption pump 100, an adsorbent container 140 includes a collection valve 130, and contains an adsorbent material 150. The adsorbent container 140 is constructed from any material known in the art for such adsorption containers. Likewise, the adsorbent material 150 is preferably activated charcoal, but may also be any other adsorbent material used in the art to collect airborne gases, particles, organic molecules and/or micro-organisms from air samples.

Still referring to FIG. 2, an insulating container 110 encapsulates the portion of the adsorbent container 140 containing the adsorbent material 150. Preferably, the insulating container 110 is a dewer vessel, that is well known in the art, but may be any other vessel capable of insulating the adsorbent container 140 to very low temperatures. In a preferred embodiment, the insulating container 110 includes a valve 120 that allows the insulating container 110 to be filled with a liquid coolant 180, preferably a cryogenic liquid. The liquid coolant 180 may include liquid nitrogen, liquid helium, liquid air, or any other liquid coolant known in the art.

In operation, the collection valve 130 is closed and the liquid coolant 180 is added to the insulating container 110 through the coolant valve 120. This severe drop in temperature creates a vacuum in the adsorbent container 140. The cryogenic adsorption pump 100 is placed in the area where air sample collection is desired, or alternatively, a sampling hose 170 is coupled to the cryogenic adsorption pump 100 and the sampling hose is extended into the desired collection area. In order to activate air collection, the collection valve 130 is opened and the vacuum created in the adsorbent container 140 effectuates the collection of an air sample. The adsorbent material 150 collects any airborne gases, particles, organic molecules and/or micro-organisms in the air sample. When the adsorbent container 140 is full, or when the desired amount of air is collected, the collection valve 130 is closed and the collection of the air sample is complete. The cryogenic adsorption pump 100 may then be removed from the collection area and stored or taken to a lab for analysis.

Still referring to FIG. 2, the cryogenic adsorption pump 100 allows a user to analyze or further store the air sample by expelling the air sample through the collection valve 130 into an awaiting storage facility or testing device. This is effectuated by opening the collection valve 130 while heating the adsorbent container 140. Preferably, the adsorbent container 140 is heated with a heating element contained within the insulating container 110 and coupled to the adsorbent container 140, as is shown by the heating elements 160 in FIG. 2. However, it should be noted that the heating elements 160 may also be configured outside of the insulating container 110 or in any other point on or around the cryogenic adsorption pump 100 that allows the heating element to heat the adsorbent container 140. It should also be noted that the adsorbent container 140 may be heated by simply draining the liquid coolant 180 through the coolant valve 120 and allowing the ambient air temperature to heat the adsorbent container 140. Likewise, even if the liquid coolant 180 is kept in the insulating container 110, the adsorbent container 140 will heat to room temperature eventually after several months.

As the adsorbent container 140 is heated, the air sample is expelled through the collection valve 130 and may be collected in a larger storage facility, or in a testing device. The heating of the adsorbent container 140 allows the air sample to be expelled and any airborne gases, particles, organic molecules and/or micro-organisms collected by the adsorbent material 150 to be expelled. Once the expulsion of the air sample is completed, the cryogenic adsorption pump 100 is cleaned and may be used again.

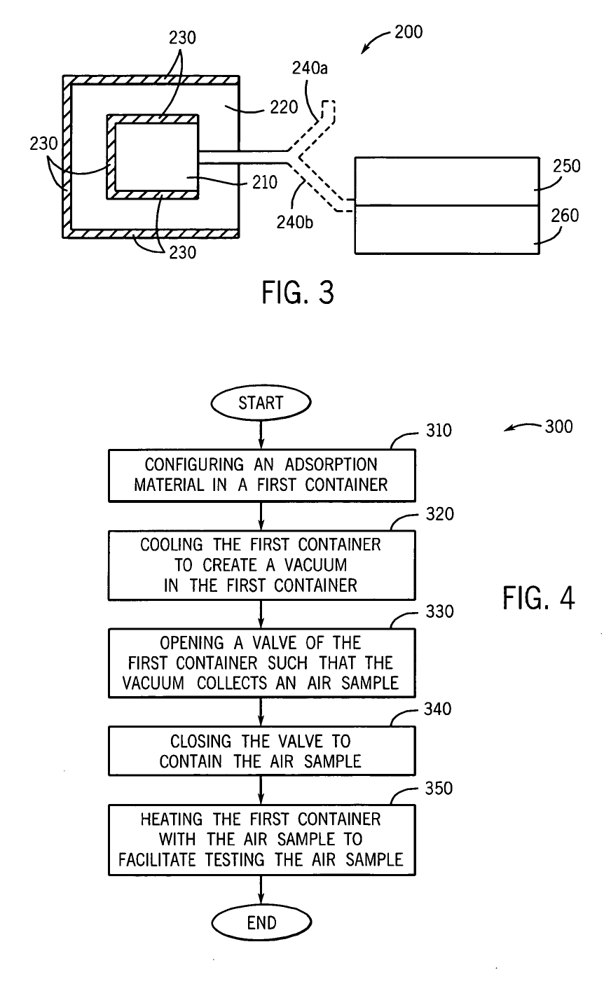

Referring to FIG. 3, a cryogenic adsorption system 200 is illustrated. Again the cryogenic adsorption system 200 includes an adsorbent container 210, an insulating container 220 and a heating means 230. As stated previously, the heating means 230 may be configured to heat either the adsorbent container 210 or the insolating container 220. The sampling hose 240a, 240b is shown in FIG. 3 in a position to both collect the air sample from a targeted area (as in 240a), as well as to deliver the collected air sample to either a storage device 250 or a testing device 260 (as in 240b). Again, when a cryogenic liquid is added to the insolating device 220, a vacuum is created in the adsorbent container 210, such that the sampling hose 240a collects an air sample in the adsorbent container 210. When the user wishes to expel the sample from the adsorbent container 210, the heating means 230 heats the adsorbent container 210, thus effectuating the expulsion of the air sample through the sampling hose 240b, into either a storage device 250 or a testing device 260.

Referring now to FIG. 4, a flow chart illustrating a method of air collection is illustrated. In step 310, an adsorption material is configured in a first container. In step 320, the first container is cooled in order to create a vacuum in the first container. In step 330, a valve of the first container is open such that the vacuum collects an air sample from the desired location. In step 340, once the first container is full or the desired air sample is collected, the valve is closed to contain the air sample. In order to expel the air sample for further storage or testing, the first container is heated in step 350. The air sample is thus expelled from the first container, and the first container may be used again to collect another air sample.

Preferably, the cryogenic adsorption pump for the collection of airborne gases, particles, organic molecules and micro-organisms has a one-liter volume, and a pressure of 5×10⁻⁶ torr is reached within 3 to 5 minutes of opening the collection valve, and the capacitance of 1 kg of the adsorbent material is approximately 45 liters of air. This new cryogenic adsorption pump and method has many advantages over the prior art including its low cost, its high efficiency of collecting air samples, and its lack of external energy requirements and of moving parts. The cryogenic adsorption pump and method requires very little maintenance, as it is self-contained and features a high-capacity for the collection of air samples. Preferably, the cryogenic adsorption pump collects 20 times of its volume, for example, a 20-liter device may collect 400 liters of air. Furthermore, the cryogenic adsorption pump and method is self-clearing, is portable, as it may be hand held or truck mounted, and supports other collection strategies and is compatible with other collection systems.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

1. A cryogenic adsorption pump for collecting an air sample, the cryogenic adsorption pump comprising:
a.) a first container having a first valve, wherein an adsorbent material is configured inside of the first container; and
b.) a second container configured to house the first container, the second container further configured to cryogenically cool the first container, wherein when the first valve is closed and the first container is cooled, a vacuum is produced in the first container such that when the first valve is opened, the air sample is collected.

2. The cryogenic adsorption pump as claimed in claim 1, wherein the first container stops collecting the air sample when the first container is full or when the valve is closed, further wherein when the first container is full, closing the valve prevents the air sample from being released.

3. The cryogenic adsorption pump as claimed in claim 1, further comprising a heating element configured to heat the first container, wherein heating the first container and opening the valve causes the air sample to be expelled from the first container.

4. The cryogenic adsorption pump as claimed in claim 1, wherein the second container cools the first container with a cryogenic liquid.

5. The cryogenic adsorption pump as claimed in claim 4, wherein the second container is a dewer vessel.

6. The cryogenic adsorption pump as claimed in claim 1, further comprising a sampling hose coupled to the first container and configured to collect the air sample.

7. A cryogenic adsorption system for collecting and analyzing an air sample, the cryogenic adsorption system comprising:
a.) an adsorption pump configured to collect the air sample, the adsorption pump including:
i.) a first container having a first valve, wherein an adsorbent material is configured inside of the first container;
ii.) a second container configured to house the first container, the second container further configured to cryogenically cool the first container, wherein when the first valve is closed and the first container is cooled, a vacuum is produced in the first container such that when the first valve is opened, the air sample is colleted;
b.) a heating element configured to heat the first container, wherein heating the first container and opening the valve causes the air sample to be expelled from the first container;
c.) a sampling hose coupled to the first container and configured to collect the air sample; and
d.) a collection device configured to receive the air sample by coupling the sampling hose to the collection device when the heating element is expelling the air sample.

8. The cryogenic adsorption system as claimed in claim 7, wherein the first container stops collecting the air sample when the first container is full or when the valve is closed, further wherein when the first container is full, closing the valve prevents the air sample from being released.

9. The cryogenic adsorption system as claimed in claim 7, wherein the second container cools the first container with a cryogenic liquid.

10. The cryogenic adsorption system as claimed in claim 9, wherein the second container is a dewer vessel.

11. The cryogenic adsorption system as claimed in claim 7, wherein the collection device is a large capacity storage device.

12. The cryogenic adsorption system as claimed in claim 7, wherein the collection device is a sampling system.

13. A method of collecting an air sample, the method comprising:
a.) configuring an adsorption material in a first container;
b.) cooling the first container with a cryogenic liquid, wherein the cryogenic liquid and the first container are configured in a second container, further wherein the cooling step causes a vacuum to form in the first container;
c.) opening a valve of the first container such that the vacuum collects an air sample; and
d.) closing the valve, thus containing the air sample in the first container.

14. The method of collecting an air sample as claimed in claim 13, further comprising heating the first container such that the air sample is expelled from the first container.

15. The method of collecting an air sample as claimed in claim 13, wherein the first container stops collecting the air sample when the first container is full or when the valve is closed, further wherein when the first container is full, closing the valve prevents the air sample from being released.

16. The method of collecting an air sample as claimed in claim 13, wherein the second container is a dewer vessel.

17. The method of collecting an air sample as claimed in claim 13, further comprising a sampling hose coupled to the first container and configured to collect the air sample.
